(19) United States
(12) Patent Application Publication
(10) Pub. No.: US 2009/0273833 A1
(43) Pub. Date: Nov. 5, 2009

(54) Single manufacturing process for great writable and erasable functional projecting screen with developing performance

(75) Inventor: Shueh-Feng Shu, Keelung City (TW)

Correspondence Address: BACON & THOMAS, PLLC, 625 SLATERS LANE, FOURTH FLOOR, ALEXANDRIA, VA, 22314-1176, US

(73) Assignee: Chien-Wei Chiu, Taipei City (TW)

(21) Appl. No.: 12/149,484

(22) Filed: May 2, 2008

(51) Int. Cl. G03B 21/60; B43L 1/00; B05D 5/04

(52) U.S. Cl. 359/443; 434/408; 427/595

(57) ABSTRACT

This is a projecting board combined the function of being a white board and developer, this invention use acrylic resin, polyester, epoxy resin combined to be a bake lacquer by mixed with dayglo, hardener and silver powder, extinction powder . . . etc materials to complete this invention that can be spread on hard or soft boards by rolling or spray after baking, it also can be wrote on the surface by erasable marker and clean it properly, the effect of the light diffusion on the surface do not cause the light faint while projecting, it do not be affected by irradiation while turn on the light indoor or sunlight downpour, the developing effect on the surface can advance the function of projection, to raise the definition, brightness and contrast of projecting reflection, to use the single baking lacquer spray can reach the great value developing effect of writing on the surface, do not need to use multi-layers to save the producing cost. This product can be made projecting screen, white board, wall coverings, plank building material, or metal building material to satisfied any kind of demands.

### FIELD OF THE INVENTION

This invention is a versatile projection screen with great developing effect, and can be use for erasable marker pens on its surface.

### BACKGROUND OF INVENTION

On the market the function of screen of projector is only for reflecting the projecting light, which is primary function of screen. It is not able to serve as white board for writing so that the user extremely inconvenient on using, e.g. to pull down the screen while projecting, to pull it up while using white board. Meanwhile now most of the projection screen are pearly-luster screen or white screen for front projection which made of cloth, which is necessary to turn off the light indoor when using the projector no matter pearly-luster screen or white screen, or it will not be clear on display because of the light restriction and the effect can be worse because the alpha particle of acrylic fiber is not fined enough.

### OBJECT OF THE INVENTION

This invention, in order to solve above-mentioned various types of shortcomings of the projection screen at present, through constant experiment and improvement, made out a kind of projection screen that could totally adapt to the environment of light and improving result of developing at last, the function that its surface can be written, combining both of the function of white board which can use for erasable marker pens and the function of projecting screen which can use for projector with better performance.

### SUMMARY OF THE INVENTION

This invention, as the bottom material, its size can be selected for use in accordance with the demand on economy and benefit by various kinds of suitable sheet metal. If it is a projection screen of the hard type and its length between 30 inches to 80 inches, can choose plastic aluminum board, aluminum board, acrylic board, galvanization board and aluminum zinc board. If for the length over 80 inches, can use glass reinforce or various metal boards. If it is a projection screen of the soft type, can use PET membrane and other heatproof plastic materials. The surface of projecting screen comprise liquid spread materials as like epoxy resin, polyester resin, acrylic resin, pearl powder, fluorescent brightening, silver powder, extinction powder, hardener . . . etc. According to the effects that the range of visual angle and brightness of projection and decide to using specific proportion of silver powder, the more silver powder used, the higher the projection screen shined; the less silver powder used, the lower the projection screen shined, to reach projection without aureole by using extinction powder to reach the projecting effect as usual by the projector The writable function on the surface can be adjusted by the mixing ratio of hardener, acrylic powder, polyester, epoxy resin.

The coating screen may spray the single baking lacquer to reach the better developing effect for writing with erasable marker pens on its surface, which is not necessary to process by multi-layer coating to decrease the producing cost. To fasten the materials it need to be baked under the specific temperature and time after spreading. Then the invention is completed.

Because the surface of this invention is processed through light diffusion, not easy to be influent by light restriction and reflection so that the performance of display is not influent with light indoor and outdoor. And the material of invention can make the display more obvious and clear, and it raise the brightness and contrast. Through special process for antifouling on the writable on the surface which can use for erasable marker pens directly and polish it, the screen can hang out on the wall, combining both of the function of white board which can use for erasable marker pens and the function of projecting screen which can use for projector with better performance.

This invention is suitable for office and school, seminar room, digital classroom and meeting room, where are need to use the projector and white board, and need to install white board and projection screen separately, it need to be used separately but at the same time. This invention combined the both functions, i.e. increase the brightness and save space and cost.

This invention can make up the projector and relevant audio-visual equipment to use, can be as part of family theater in house and as part of KTV in audio-visual place, not only there are not limited on the size of the screen but also much lower the cost compare with other PDP or TFT-LCD monitor, and not decrease the result of display, the writable function on the surface equal special antifouling character which is easier to clean and maintain. This invention can be applied to plank building material, wall coverings or metal building material using, can be the building material or wall coverings with projecting and writable functions.

On the marker at the present, to raise the developing result need to collocated the high-end projector, this invention just need to use general projector to reach the same even better effect, to lower the purchase cost of buying high-end projector, and this character of writable on the surface, included white board and developing screen functions.

### A BRIEF DESCRIPTION OF THE DRAWING

FIG. 1 show the manufacturing process of this invention.

FIG. 2 show the finished product of this invention.

The meanings of the number on the drawing are as below.
10 bottom board
20 liquefied coating
30 screens coating
40 projection screen finished products

### DETAILED DESCRIPTION OF THE INVENTION

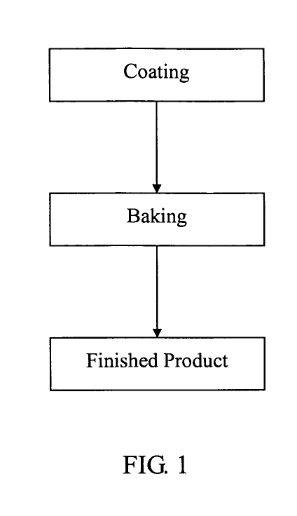

With reference to the drawings, FIG. 1 show the manufacturing process of this invention. The steps of the manufacturing process are as below.

The first step is spreading. Choose a bottom board (10) then use liquefied coating to spread on the bottom board (10) to make the screens coating (30). If the material of bottom board (10) is hard type, it can be aluminum board, plastic aluminum board, acrylic board, glass reinforce, galvanization board or aluminum zinc board. If the material is soft type, it can be PET membrane and other plastic heatproof materials. The materials of liquefied coating (20) included epoxy resin, polyester resin, acrylic resin, pearl powder, fluorescent brightening, silver powder, extinction powder, and hardener, to spread by rolling method or spraying method, can be antifouling and hard surface after baking, otherwise can adjust the ratio of silver powder to change the brightness and visual angle. the more silver powder used, the higher the brightness shined; the less silver powder used, the lower the brightness shined, by the way to use extinction powder to make the projection without aureole and increase the range of visual angle. to reach the projecting effect as usual by the projector

The second step is baking. Bake for about 20-60 seconds with the oven of 150-300 degrees Centigrade, according to the temperature of oven to make the baking time, rely mainly on liquefied coating (20) can be completely hardenned and finished.

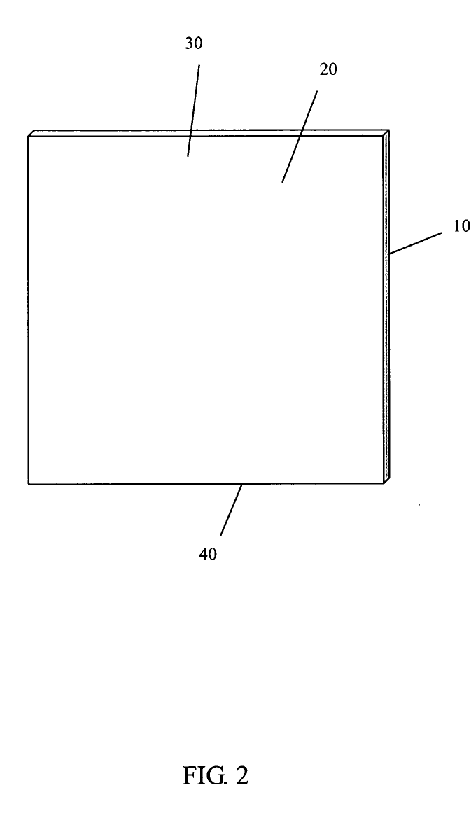

The FIG. 2 shows the finished product (40). This invention does not have light restriction in outdoor or on the light indoor while projector displayed and the display is more obvious and clear. To adapt for general projector can reach the effect of high-end projector, the cost is much economic compare with other kinds of big size screen on the market and good result, it has the great value with erasable function after wrote by marker pens.

In accordance with the embodiments described above, as know that this invention has already had progress on originality and utilization, and has not seen that there is the same or similar invention that has appeared on the market and seen in the domestic and international publication, also have novelty, has already accorded with the regulations of patent law.

We claim:

1. A high-developed projecting screen which can use for erasable marker pens on its surface comprising,
(a) the bottom board using as projector that could be made of hard materials like as aluminum board, plastic aluminum board, acrylic board, glass reinforce, galvanization board and aluminum zinc board etc. or soft materials like as PET membrane or other heatproof plastic materials;
(b) a coating screen using as the projecting surface that spreading liquid material can be some baking lacquer material like as acrylic resin, polyester, epoxy resin etc. is mixed up with silver powder, hardener, extinction powder, fluorescent brightening then it can be dried after baking for 10-60 seconds and heated with the oven of 200-300 degrees Centigrade, which backing time is dependent on the temperature of oven;

2. The material of claim 1 wherein the coating screen used with erasable marker pens for high-developed projecting screen, that silver powder of its screen coating can be increased to improve the brightness.

3. The material of claim 1 wherein the coating screen used with erasable marker pens for high-developed projecting screen, that the extinction powder spreading on its coating screen can be increased to improve the range of visible angle and reach the projecting effect as usual by the projector.

4. The process of claim 1 wherein the coating screen may spray the single baking lacquer to reach the better developing effect for writing with erasable marker pens on its surface, which is not necessary to process by multi-layer coating to decrease the producing cost, but also may process by multi-layer coating to enhance the developing effect.
